(19) United States
(12) Patent Application Publication
(10) Pub. No.: US 2022/0049367 A1
(43) Pub. Date: Feb. 17, 2022

(54) HYBRID BIPOLAR PLATE AND METHOD OF MAKING THE SAME

(71) Applicant: OHMIUM INTERNATIONAL, INC.,, Incline Village, NV (US)

(72) Inventors: Arne BALLANTINE, Incline Village, NV (US); Vikas Devoji CHAWAN, Bangalore (IN); Muralidhar VENKATRAMAN, Bangalore (IN); Balasubramanian LAKSHMANAN, Rochester Hills, MI (US); Chockkalingam KARUPPAIAH, Fremont, CA (US)

(21) Appl. No.: 17/402,821

(22) Filed: Aug. 16, 2021

(30) Foreign Application Priority Data
Aug. 14, 2020 (IN) 202041035043
Jun. 23, 2021 (IN) 202111028250

(51) Int. Cl. C25B 11/036; C25B 11/032; C25B 1/04; C25B 9/23; C25B 9/77; C25B 9/75; C25B 11/091

(52) U.S. Cl. CPC C25B 11/036; C25B 11/032; C25B 1/04; C25B 11/091; C25B 9/77; C25B 9/75; C25B 9/23

(57) ABSTRACT

A bipolar plate includes at least one electrically conductive plate having an anode flow field on an anode major side and a cathode flow field on a cathode major side opposite to the anode major side, an electrically insulating first capping plate containing a first plenum area, and located over the anode major side, and an electrically insulating second capping plate containing a second plenum area, and located over the cathode major side. The at least one electrically conductive plate, the first capping plate and the second capping plate are bonded to each other.

### CROSS-REFERENCE TO RELATED APPLICATION

This application claims the benefit of Indian Provisional Patent Application No. 202041035043, filed on Aug. 14, 2020, and Indian Provisional Patent Application No. 202111028250, filed on Jun. 23, 2021, the entire contents of each of which are incorporated herein by reference.

### FIELD

This disclosure is directed to electrolyzers in general and, in particular, to a bipolar plate for an electrolyzer and method of making thereof.

### BACKGROUND

Proton exchange membrane (PEM) electrolyzers may be used to convert water into separate hydrogen and oxygen streams. Such PEM electrolyzers include a plurality of cells, with each cell including a polymer electrolyte located between an anode electrode and a cathode electrode. Anode side and cathode side porous gas diffusion layers are located adjacent to the respective anode and cathode electrodes. A PEM cell stack may be formed by stacking a plurality of cells separated by electrically conducting plates.

### SUMMARY

According to one embodiment, a bipolar plate includes at least one electrically conductive plate having an anode flow field on an anode major side and a cathode flow field on a cathode major side opposite to the anode major side, an electrically insulating first capping plate containing a first plenum area, and located over the anode major side, and an electrically insulating second capping plate containing a second plenum area, and located over the cathode major side. The at least one electrically conductive plate, the first capping plate and the second capping plate are bonded to each other.

According to another embodiment, a method of forming a bipolar plate comprises providing at least one electrically conductive plate having an anode flow field on an anode major side and a cathode flow field on a cathode major side opposite to the anode major side, providing an electrically insulating first capping plate containing a first plenum area such that the first capping plate is located over the anode major side, providing an electrically insulating second capping plate containing a second plenum area, such that the second capping plate is located over the second major side, and bonding the at least one electrically conductive plate, first capping plate and the second capping plate to each other.

### BRIEF DESCRIPTION OF THE DRAWINGS

Aspects of this disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective cut-away view of a PEM electrolyzer.

FIG. 2A is a three-dimensional perspective exploded view of an electrochemical cell, according to various embodiments.

FIG. 2B is a vertical cross-sectional view of the electrochemical cell of FIG. 2A in an assembled configuration, according to various embodiments.

FIG. 3 is a three-dimensional perspective view of an electrochemical stack including a plurality of electrochemical cells, according to various embodiments.

FIG. 4A is a three-dimensional perspective exploded view of a hybrid plate, according to various embodiments.

FIG. 4B is a vertical cross-sectional view of the hybrid plate of FIG. 4A in an assembled configuration, according to various embodiments.

FIG. 5A is a top plan view of an anode plate, according to various embodiments.

FIG. 5B is a top perspective view of the anode plate of FIG. 5A, according to various embodiments.

FIG. 5C is a bottom perspective view of the anode plate of FIG. 5A, according to various embodiments.

FIG. 6A is a top plan view of a cathode plate, according to various embodiments.

FIG. 6B is a top perspective view of the cathode plate of FIG. 6A, according to various embodiments.

FIG. 6C is a bottom perspective view of the cathode plate of FIG. 6A, according to various embodiments.

FIG. 7A is a plan view of a capping plate, according to various embodiments.

FIG. 7B is a close-up perspective view of a portion of the capping plate of FIG. 7A, according to various embodiments.

FIG. 8A is a three-dimensional perspective view of a core molding insert used in the formation of a hybrid plate, according to various embodiments.

FIG. 8B is a three-dimensional close-up perspective view of the core molding insert of FIG. 8A, according to various embodiments.

FIG. 9A is a top three-dimensional view of a core molding insert with components of a hybrid plate assembled thereon, according to various embodiments.

FIG. 9B is a top three-dimensional close-up view of the core molding insert with components of a hybrid plate assembled thereon of FIG. 9A, according to various embodiments.

FIG. 10A is a top three-dimensional view of a hybrid plate being removed from the core molding insert, according to various embodiments.

FIG. 10B, is a plan view of a hybrid plate after it has been removed from the core molding insert of FIG. 10A, according to various embodiments.

FIG. 11 is a plan view of a capping plate formed as two separable sections that may be bonded to an anode or cathode plate, according to various embodiments.

FIG. 12A is a side view of a metal component and a plastic component that are aligned to be bonded by a solvent process, according to various embodiments.

FIG. 12B is a side view of the metal component and the plastic component of FIG. 12A with a solvent that has been applied as part of a solvent bonding process, according to various embodiments.

FIG. 12C is a side view of the metal component and the plastic component that have been bonded to one another by a solvent bonding process, according to various embodiments.

FIG. 13A is a side view of a metal component and a plastic component that are aligned to be bonded by an adhesive, according to various embodiments.

FIG. 13B is a side view of the metal component and the plastic component of FIG. 12A with an adhesive that has been applied as part of a bonding process, according to various embodiments.

FIG. 13C is a side view of the metal component and the plastic component that have been bonded to one another by an adhesive, according to various embodiments.

FIG. 14A is a three-dimensional perspective exploded view of an electrochemical cell, according to various embodiments.

FIG. 14B is a top plan view of the electrochemical cell of FIG. 14A, according to various embodiments.

FIG. 14C is a three-dimensional perspective view of the electrochemical cell of FIG. 14A, according to various embodiments.

FIG. 14D is a vertical cross-sectional view of an edge portion of an electrochemical cell of FIG. 14A containing plastic component and a metal component that have been bonded by an adhesive, according to various embodiments.

FIG. 15 is a vertical cross-sectional view of a plastic component and a metal component that may be bonded by an ultrasonic welding process, according to various embodiments.

FIG. 16 is a three-dimensional perspective view of a plastic component that is formed directly on a metal component, according to various embodiments.

### DETAILED DESCRIPTION

The disclosed embodiments are described more fully hereinafter with reference to the accompanying figures, in which exemplary embodiments are shown. The foregoing may, however, be embodied in many different forms and should not be construed as being limited to the exemplary embodiments set forth herein. All fluid flows may flow through conduits (e.g., pipes and/or manifolds) unless specified otherwise.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

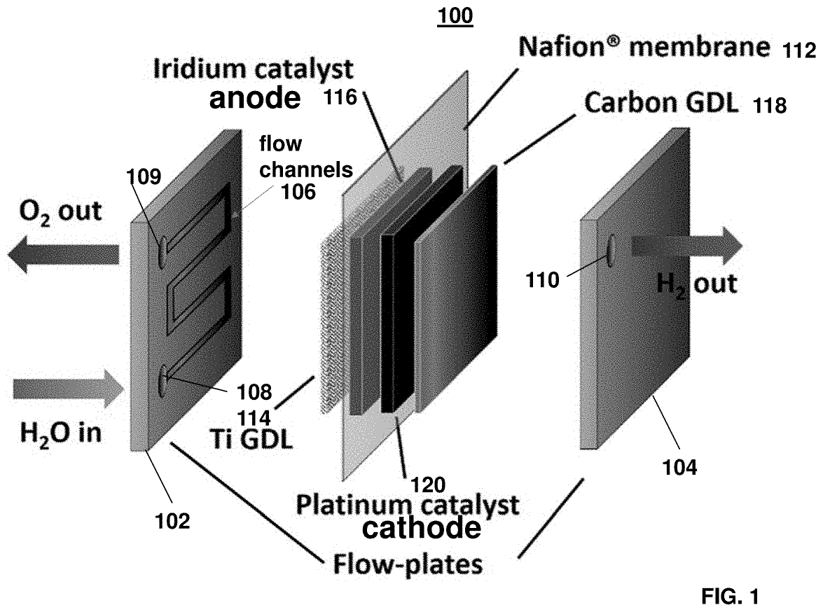

FIG. 1 is a perspective cut-away view of a PEM electrolyzer cell that is described in an article by Greig Chisholm et al., entitled “3D printed flow plates for the electrolysis of water: An economic and adaptable approach to device manufacture” that was published in Energy Environ. Sci., 2014, 7, 3026-3032. The PEM electrolyzer 100 comprises a PEM electrolyzer cell which may include an anode side flow plate 102 and a cathode side flow plate 104 with fluid flow channels 106 and respective openings 108, 109, 110, a PEM polymer electrolyte 112 located between the flow plates 102, 104, an anode side gas diffusion layer 114 located between the electrolyte 112 and the anode side flow plate 102, an anode electrode 116 located between the anode side gas diffusion layer 114 and the electrolyte 112, a cathode side gas diffusion layer 118 located between the electrolyte 112 and the cathode side flow plate 104, and a cathode electrode 120 located between the cathode side gas diffusion layer 118 and the electrolyte 112.

The anode side flow plate 102 may include a water inlet opening 108, an oxygen outlet opening 109 and a water flow channel (e.g. tortuous path groove) 106 connecting the water inlet opening 108 and the oxygen outlet opening 109 in the side of the flow plate 102 facing the anode side gas diffusion layer 114. The anode side gas diffusion layer 114 may include a porous titanium layer. The cathode side gas diffusion layer 118 may include a porous carbon layer. The anode electrode 116 may include any suitable anode catalyst, such as an iridium layer. The cathode electrode 120 may include any suitable cathode catalyst, such as a platinum layer. Other noble metal catalyst layers may also be used for the anode and/or cathode electrodes. The electrolyte 112 may include any suitable proton exchange (e.g., hydrogen ion transport) polymer membrane, such as a Nafion® membrane composed of sulfonated tetrafluoroethylene based fluoropolymer-copolymer having a formula C₇HF₁₃O₅S.C₂F₄.

In operation, water is provided into the water flow channel 106 through the water inlet opening 108. The water flows through the water flow channel 106 and through the anode side gas diffusion layer 114 to the anode electrode 116. The water is electrochemically separated into oxygen and hydrogen at the anode electrode 116 upon an application of an external current or voltage between the anode electrode 116 and the cathode electrode 120. The oxygen diffuses back through the anode side gas diffusion layer 114 to the anode side flow plate 102 and exits the electrolyzer 100 through the oxygen outlet opening 109. The hydrogen ions diffuse through the electrolyte 112 to the cathode electrode 120 and then exit the electrolyzer 100 through the cathode side gas diffusion layer 118 and the hydrogen outlet opening 110 in the cathode side flow plate 104.

A porous titanium layer (e.g., sheet) may be used as the anode side gas diffusion layer (i.e., transport layer) 114. In one embodiment, the porous titanium layer (e.g., sheet) that is used as an anode side gas diffusion layer 114 is formed by a powder process. In one embodiment, the powder process includes tape casting. After the porous titanium sheet is sintered, it may be coated on both sides (e.g., on the anode electrode side and the flow plate side) with a conductivity enhancing and/or corrosion resistant coating, such as a platinum and/or gold coating to provide good conductivity and corrosion resistance. The coating may be formed by physical vapor deposition, such as evaporation.

In another embodiment, the porous titanium layer (e.g., sheet) that is used as an anode side gas diffusion layer 114 is formed by a powder metallurgical technique, in which a titanium powder is pressed into a porous titanium sheet using compaction process. The compacted sheet is then sintered to yield a gas diffusion layer (e.g., sheet) with an established metallurgical bond. The porous titanium sheet may have a porosity between 40 and 60 percent.

In a conventional bipolar plate configuration, anode and cathode plates (i.e., anode and cathode flow plates) are formed of an electrically conductive material and then compressed or sealed together with dielectric materials to form a bipolar plate. The disclosed embodiments provide a bipolar plate assembly for an electrochemical cell that includes a bipolar separator plate. The electrochemical cell may be a fuel cell, electrolyzer cell, or other cell configured to allow ion transport. The disclosed assembly is formed using a bonding process that is more cost effective than conventional diffusion bonding processes. Further, the assembly is configured such that the anode and cathode plates may have a reduced area relative to conventional anode and cathode plates, leading to reduced material costs.

According to disclosed embodiments, each of a plurality of stack elements are bounded by hybrid plates, with each hybrid plate including an anode plate, a cathode plate, and capping plates located on the respective sides of the anode plate and the cathode plate. The anode plate, the cathode plate, and the two capping plates are bonded together with a non-conductive (i.e., electrically insulating) material, such as plastic. Disclosed embodiments may include a bipolar plate cell assembly that is formed with an electrically conductive first element that may be easily stamped, etched, or otherwise formed. The first element may comprise a pure metal, a metal alloy or carbon. The first element may be configured to create a cell flow area. The assembly may include an electrically insulating second element that is easily molded onto the first element to create flow features. The second element may comprise plastic. For example, the second element may be configured to include a plenum area as well as an area for compression features and features that provide sealing of the cell assembly and plenum perimeter.

The cell assembly may further include a third element that is bonded onto the first element and the second element, or molded in place to cover the connection features between the first element and the second element. The cell assembly may further include a fourth element that may be added if and when a covering is required on both sides of the cell assembly including the first and second elements. For certain applications, it may be advantageous to include a conductivity enhancing coating. According to various embodiments, such a conductivity enhancing coating may be placed only on the first element which creates the cell flow area. For certain applications, it may be advantageous to include a corrosion prevention coating. According to various embodiments, such a corrosion prevention coating may be placed only on a metal portion of the first element, which creates the cell flow area.

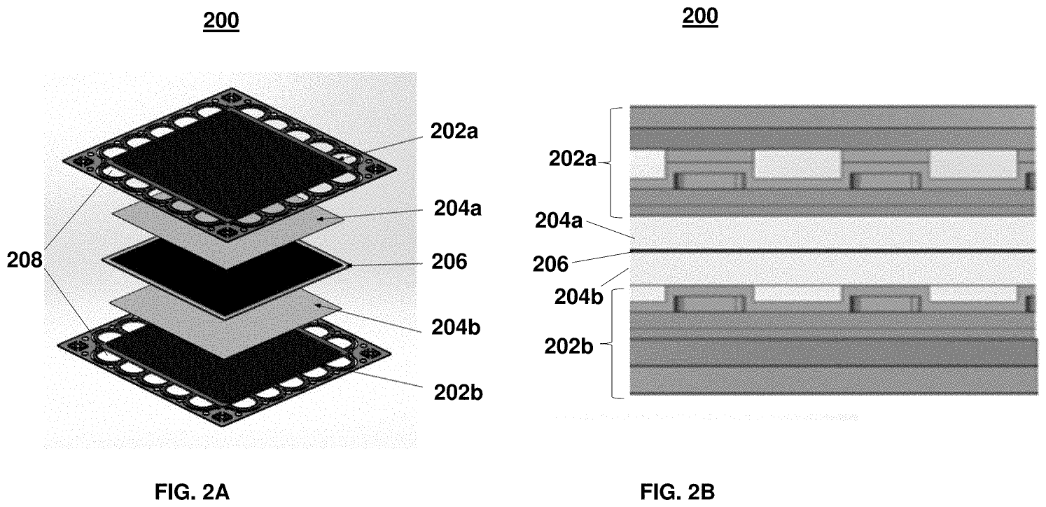

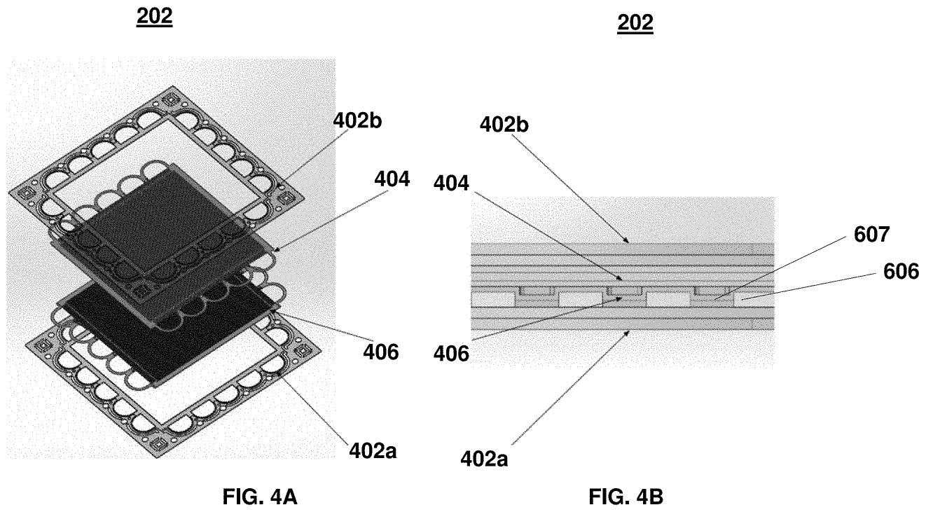

FIG. 2A is a three-dimensional perspective exploded view of an electrochemical cell 200, and FIG. 2B is a vertical cross-sectional view of the electrochemical cell 200 of FIG. 2A in an assembled configuration, according to various embodiments. The electrochemical cell 200 of FIGS. 2A and 2B may include a first hybrid plate 202a, a second hybrid plate 202b, an anode gas diffusion layer 204a, a cathode gas diffusion layer 204b, and a membrane electrode assembly (MEA) 206. The MEA 206 may include an electrolyte membrane 112, an anode 116, and a cathode 120 (e.g., see FIG. 1 and related description, above). The first hybrid plate 202a and the second hybrid plate 202b may each include additional components, as described in greater detail with reference to FIGS. 4A and 4B, below. The first hybrid plate 202a and the second hybrid plate 202b have aligned fluid rises channels 208 through which fluids flow between adjacent cells 200 in a stack.

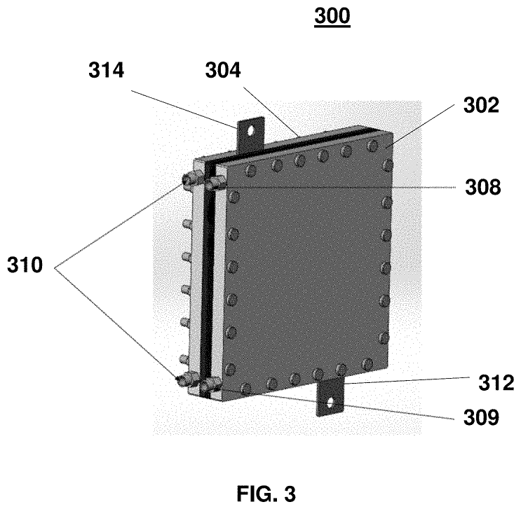

FIG. 3 is a three-dimensional perspective view of an electrochemical stack 300 including a plurality of electrochemical cells 200, according to various embodiments. The electrochemical stack 300 may be formed by stacking a plurality of the electrochemical cells 200 shown in FIGS. 2A and 2B. In this regard, the electrochemical stack 300 may include a plurality of MEAs 206. Each of the MEAs 206 may be sandwiched between an anode gas diffusion layer 204a and a cathode gas diffusion layer 204b, as shown in FIG. 2B. A first hybrid plate 202a may act as a top hybrid plate 202a for a first electrochemical cell and may act as a bottom hybrid plate for another electrochemical cell (not shown) located above the hybrid plate 202a. Similarly, each second hybrid plate 202b may act as a bottom plate for the first electrochemical cell and may act as a top hybrid plate for yet another electrochemical cell (not shown) located below the hybrid plate 202b.

As shown in FIG. 3, the electrochemical stack 300 may include an anode end plate 302 and a cathode end plate 304. The anode end plate 302 may include an anode inlet 308 and an anode outlet 309. The anode inlet 308 may be configured to receive water as input and the anode outlet 309 may be configured to provide oxygen, generated by electrolysis of the input water, as output. The cathode end plate 304 may include hydrogen outputs 310, which may be configured to provide hydrogen, generated by electrolysis of the input water, as output. The anode end plate 302 may include an anode electrical connection 312 and the cathode end plate 304 may include a cathode electrical connection 314. The electrochemical stack 300 may be configured to perform an electrolysis process as follows. The anode electrical connection 312 may be connected to one terminal of a voltage source and the cathode electrical connection 314 may be connected to an opposite polarity terminal of a voltage source. Application of a voltage between the anode electrical connection 312 and the cathode electrical connection 314 may cause water received by the anode inlet to be electrolyzed to thereby dissociate water molecules into hydrogen and oxygen.

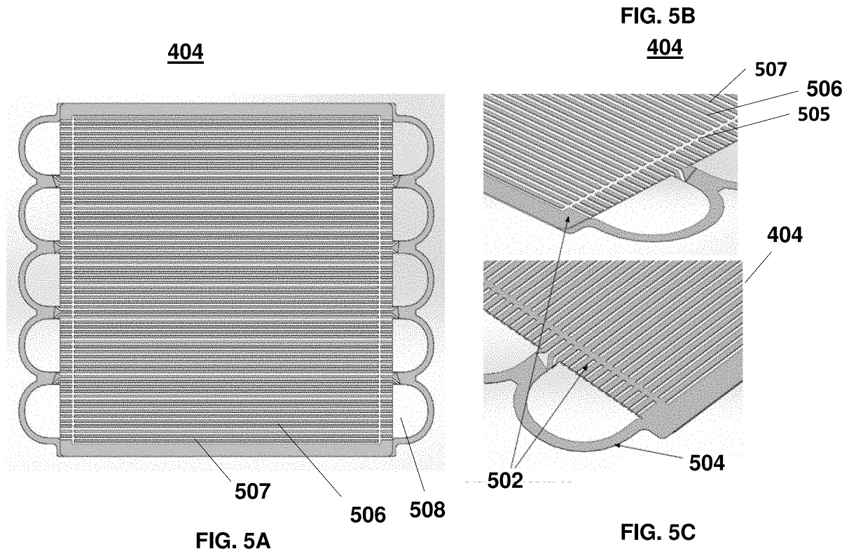

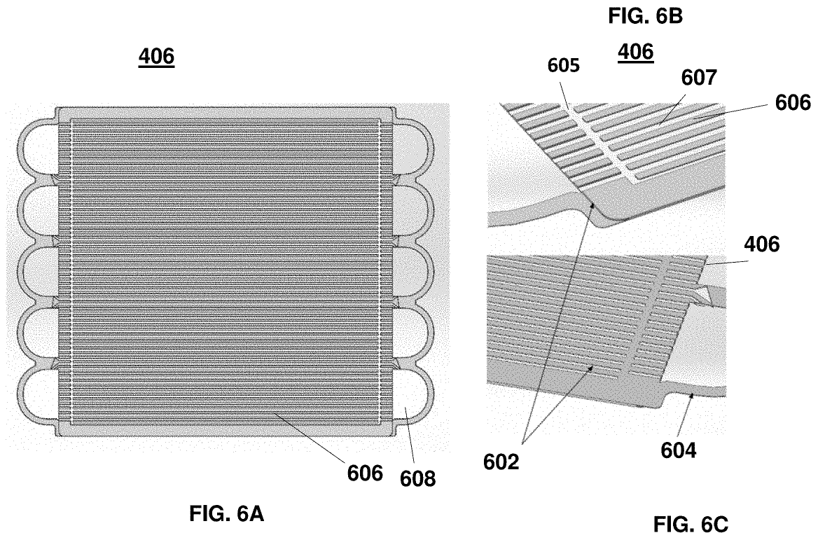

FIG. 4A is a three-dimensional perspective exploded view of a hybrid plate 202, and FIG. 4B is a vertical cross-sectional view of the hybrid plate 202 of FIG. 4A in an assembled configuration, according to various embodiments. The hybrid plate of FIGS. 4A and 4B may include a first pre-molded capping plate 402a and a second pre-molded capping plate 402b. The hybrid plate further may include an anode plate 404 and a cathode plate 406. As described in greater detail with reference to FIGS. 5A to 6B, below, the anode plate 404 and the cathode plate 406 may include respective channels 506 and 606 oriented along orthogonal directions (e.g., horizontally orthogonal in FIGS. 5A and 6A) to form a cross flow bipolar plate 202. Alternatively, the respective channels 506 and 606 may be oriented in parallel directions to form a co-flow or counter flow bipolar plate 202.

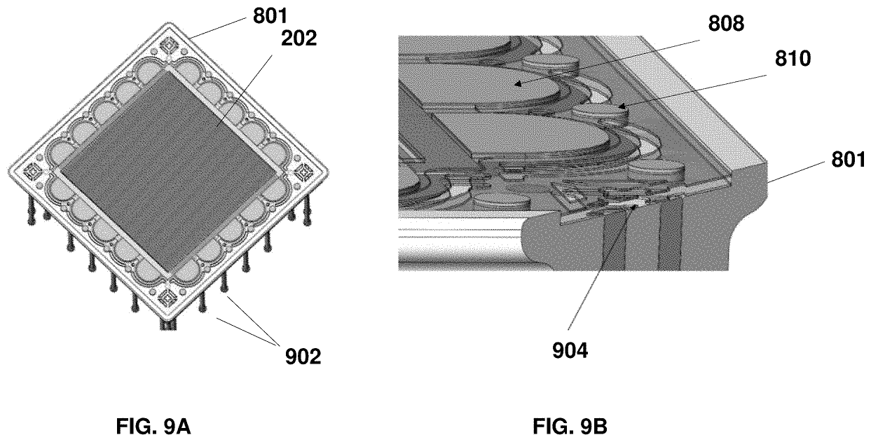

The hybrid plate of FIGS. 4A and 4B may be assembled as follows. The cathode plate 406 may be placed over the first pre-molded capping plate 402a. The anode plate 404 may then be placed over the cathode plate 406 such that channels in the respective anode plate 404 and cathode plate 406 have an orthogonal orientation relative to one another. The second pre-molded capping plate 402b may then be placed over the anode plate 404. The various components of the assembly may then be secured to one another in various ways. For example, a plastic material may be molded around the periphery of the assembly, as described in greater detail with reference to FIG. 9B.

FIG. 5A is a top plan view of an anode plate 404, FIG. 5B is a top perspective view of the anode plate 404 of FIG. 5A, and FIG. 5C is a bottom perspective view of the anode plate 404 of FIG. 5A, according to various embodiments. Similarly, FIG. 6A is a top plan view of a cathode plate 406, FIG. 6B is a top perspective view of the cathode plate 406 of FIG. 6A, and FIG. 6B is a bottom perspective view of the cathode plate 406 of FIG. 6A, according to various embodiments.

The anode plate 404 may include an electrically conductive material, such as a metal, metal alloy or carbon. The anode plate 404 may include plurality of stamped features 502. In an example embodiment, the anode plate 404 may have a thickness of 0.1 to 0.5 mm, such as approximately 0.2 mm. Other embodiments may include anode plates 404 having various other thicknesses. Further, the stamped featured 502 may formed only on an active side of the anode plate 404. In this example, the stamped features 502 include a flow field including an optional fluid flow manifold 505 and plurality of parallel channels 506 separated by ribs 507 on a top surface of the anode plate 404. The channels 506 may extend perpendicular to the flow manifold 505 which distributes the fluid across the channels 506. For example, as shown in FIG. 5A, the channels are formed along a horizontal direction. The anode plate 404 may further include a plurality of first molded-on (e.g., plastic) hoop features 504. In this example, the first molded-on hoop features 504 are configured to form plenum areas 508.

The cathode plate 406 may include an electrically conductive material, such as a metal, metal alloy or carbon. The cathode plate 406 may include plurality of stamped features 602. In an example embodiment, the cathode plate 406 may have a thickness of 0.1 to 0.5 mm, such as approximately 0.2 mm. Other embodiments may include cathode plates 406 having various other thicknesses. Further, the stamped featured 602 may formed only on an active side of the cathode plate 406. In this example, the stamped features 602 include a flow field including an optional fluid flow manifold 605 and a plurality of parallel channels 606 separated by ribs 607 on a top surface of the cathode plate 406. For example, as shown in FIG. 6A, the channels may be formed along a horizontal direction. The cathode plate 406 may further include a plurality of second molded-on hoop features 604. In this example, the second molded-on (e.g., plastic) hoop features 604 are configured to form plenum areas 608.

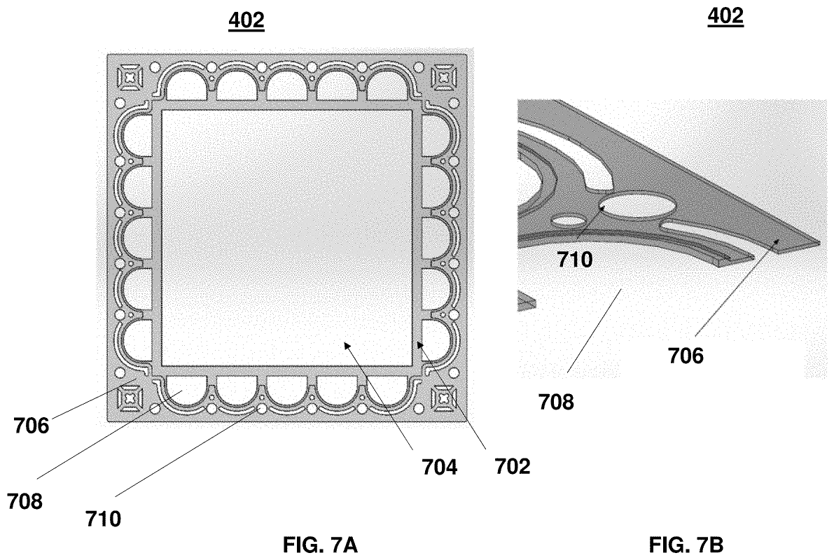

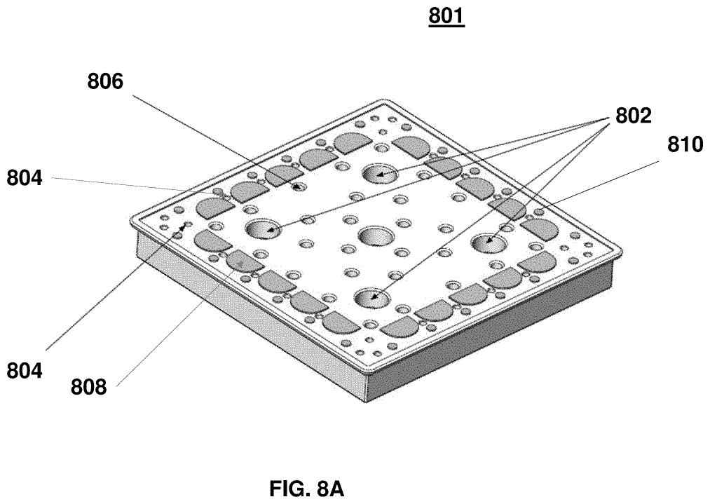

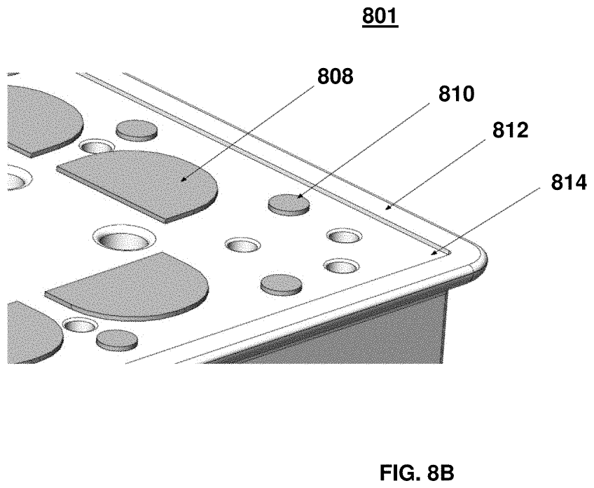

FIG. 7A is a top plan view of a capping plate 402, and FIG. 7B is a close-up perspective view of a portion of the capping plate 402 of FIG. 7A, according to various embodiments. The capping plate 402 may comprise an electrically insulating material, such as plastic. The capping plate 402 may include a hollow frame 702 structure that is configured to support an anode plate 404 or a cathode plate 406 (e.g., see FIGS. 4A to 6B). The capping plate 402 further may include an open area 704 over which the anode plate 404 or cathode plate 406 may be secured to the frame 702. In an example embodiment, the capping plate 402 may have a thickness of 0.5 to 1 mm, such as approximately 0.8 mm. Other embodiments may include various other thicknesses. The capping plate 402 may further include one or more features 706 that allow liquid plastic to flow in a bonding process, as described in greater detail below with reference to FIG. 9B. For example, the one or more features 706 may include a flow channel, pocket or step feature that is configured to allow liquid plastic to flow. The one or more features 706 may have a depth of approximately 0.3 mm in one embodiment. Other embodiments may include one or more features 706 having various other depths. The capping plate 402 may further include one or more apertures 710. For example, aperture 710 may be configured as a bolt hole that may allow a bolt to pass through the aperture 710 to thereby secure the capping plate to other components of a hybrid plate (e.g., see FIGS. 4A and 4B) or to a molding insert, as described in greater detail with reference to FIGS. 8A and 8B, below. The capping plate may further include open plenum areas 708. The plenum areas 708 are aligned with the plenum areas 508 and 608 in the anode and cathode plates to form fluid riser channels 208 for transporting fluids, such as water, air and hydrogen between the electrochemical cells in the stack 300.

The bonding process, mentioned above, may be an injection molding process in which the components of the hybrid plate (e.g., see FIGS. 4A and 4B) may be bonded together through pressure injection of a plastic material. For example, in an embodiment, the injection molding process may include injection of a liquid polysulfone (or another suitable flowable plastic) and compaction of the various components of a hybrid plate. As described in greater detail below, this bonding process is in contrast to diffusion bonding of metal alloy plates used in conventional approaches.

FIG. 8A is a three-dimensional perspective view of a core molding insert 801 used in the formation of a hybrid plate, and FIG. 8B is a three-dimensional close-up perspective view of the molding insert 801 of FIG. 8A, according to various embodiments. In this example embodiment, the core molding insert 801 may include five M24 countersunk holes 802 configured to fasten the components of a hybrid plate (e.g., see FIGS. 4A and 4B) to a cavity of the core molding insert 801. The core molding insert 801 may further include three 19/64 inch ejector pin holes 804 in each of the corners of the cavity and in between plenum inserts 808 (for a total of 28 holes). The core molding insert 801 may further include a plurality of ½ inch ejector holes 806 lining an inside area between plenum inserts 808 (a total of 28 holes). Other embodiments may include various other sizes and numbers of ejector pin holes. As shown in the close-up view of FIG. 8B, the core molding insert 801 may include plenum inserts 808 and raised lands 810 that may be used for the formation of bolt holes. The core molding insert 801 may further include a parting surface 812 and a pocket or step feature 814 that may be configured to allow liquid plastic to flow during an injection molding bonding process, as mentioned above.

FIG. 9A shows a top three-dimensional view of a core molding insert 801 with components of a hybrid plate 202 assembled thereon, and FIG. 9B is a top three-dimensional close-up view of the core molding insert 801 with the components of a hybrid plate 202 assembled thereon of FIG. 9A, according to various embodiments. The core molding assembly further may include various ejector pins 902 installed in the various ejector pin holes (e.g., see ejector pin holes 802, 804, and 806 in FIG. 8A). The ejector pins 902 may be used to eject the hybrid plate 202 after the components of the hybrid plate 202 have been bonded together using a bonding process (e.g., by injection molding).

FIG. 9B shows a cross-sectional view of an edge of the core molding insert 801 including channels 904 that are configured to allow liquid plastic to flow in an injection molding process. Before injecting liquid plastic to bond the components of the hybrid plate 202, a cover (not shown) may be placed over the core molding insert 801 to close the structure. The bonding process may include injection polysulfone or other injectable plastic into the channels 904. The plenum inserts 808 (e.g., see FIGS. 8B and 9B) prevent liquid plastic from filing plenum areas 708 of the capping plate 402 (e.g., see FIGS. 7A and 7B). Similarly, raised lands 810 that may be used to prevent liquid plastic from filing bolt holes 710 of the capping plate 402 (e.g., see FIGS. 7A and 7B). During the bonding process, the core molding insert 801 may be surrounded with circulating water (not shown) to cool the liquid plastic to create a solid hybrid plate.

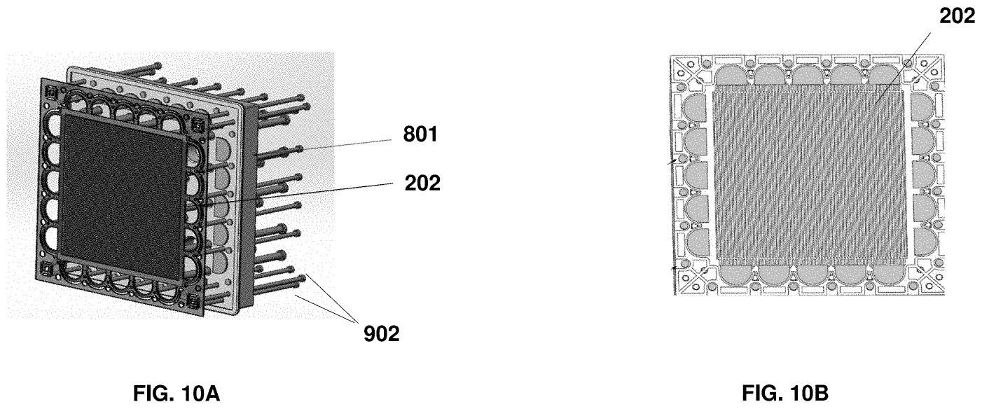

FIG. 10A is a top three-dimensional view of a hybrid plate 202 being removed from the core molding insert 801, and FIG. 10B, is a plan view of the hybrid plate 202 after it has been removed from the core molding insert 801 of FIG. 10A, according to various embodiments. After the bonding process has been completed, a cover (not shown) may be removed from the core molding insert 801. Ejector pins 902 may then be used to remove the hybrid plate 202 from the core molding insert 801. In this regard, a force may be applied to ejector pins 902 to push the injector pins up through the core molding insert 801 thereby forcing the hybrid plate 202 out of the core molding insert 801.

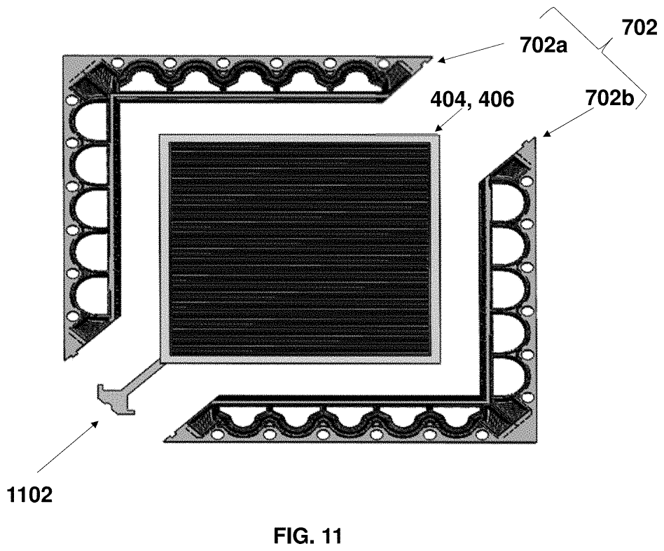

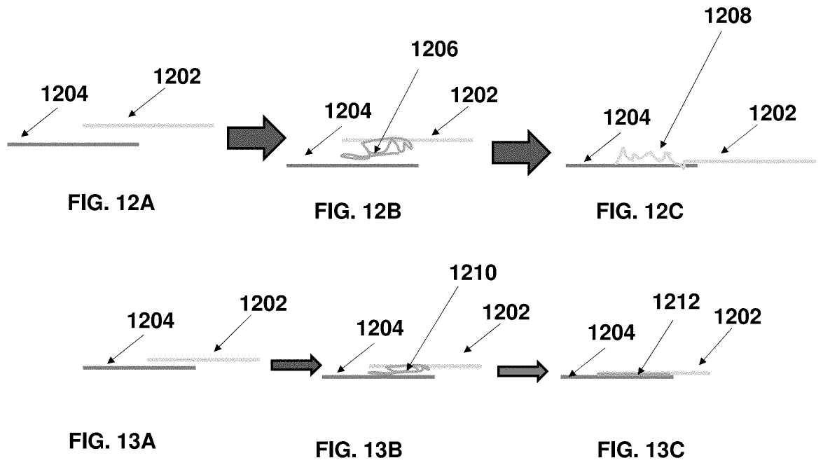

FIG. 11 is a plan view of a capping plate 702 formed as two separable sections that may be bonded to an anode or cathode plate, according to various embodiments. In this regard, the capping plate may include a first section 702a and a second section 702b. The first section 702a and the second section 702b may be fitted over edges of the anode plate 404 or the cathode plate 406. The first section 702a and the second section 702b may be bonded to edges of the anode plate 404 or the cathode plate 406 using various processes, such as plastic molding processes. Alternatively, as described in greater detail with reference to FIGS. 12A to 15, the first section 702a and the second section 702b may be bonded to edges of the anode plate 404 or the cathode plate 406 by gluing, by using a solvent process, by ultrasonic welding, etc. In certain embodiments, the anode plate 404 or cathode plate 406 may include a coupling feature 1102 that may be configured to mechanically engage the first section 702a and the second section 702b to thereby couple the first section 702a and the second section 702 to the anode plate 404 or the cathode plate 406.

FIGS. 12A to 12C illustrate a solvent bonding process whereby a plastic component 1202 and a metal component 1204 may be bonded to one another, according to various embodiments. In FIG. 12A, the plastic component 1202 and the metal component 1204 may be aligned relative to one another prior to bonding by a solvent process. For example, plastic component may be an edge of a capping plate 402a or 402b (e.g., see FIGS. 4A and 4B), or may be an edge of a first section 702a or a second section 702b of a capping plate 702 (e.g., see FIG. 11). Similarly, the metal component 1204 may be an edge of an anode plate 404 or a cathode plate 406 (e.g., see FIGS. 4A, 4B, and 11). A solvent 1206 may be applied between the plastic component 1202 and the metal component 1204, as shown in FIG. 12B. The solvent 1206 may act to dissolve a portion 1208 of the plastic component 1202. The dissolved portion 1208 may thereby form a bond with the metal component 1204 thereby bonding the plastic component 1202 and the metal component 1204 to one another, as shown in FIG. 12C. During the bonding process, the plastic component 1202 and the metal component 1204 may be held together under pressure. For example, the plastic component 1202 and the metal component 1204 may be held together with clamps or may be held together with various other fastening devices.

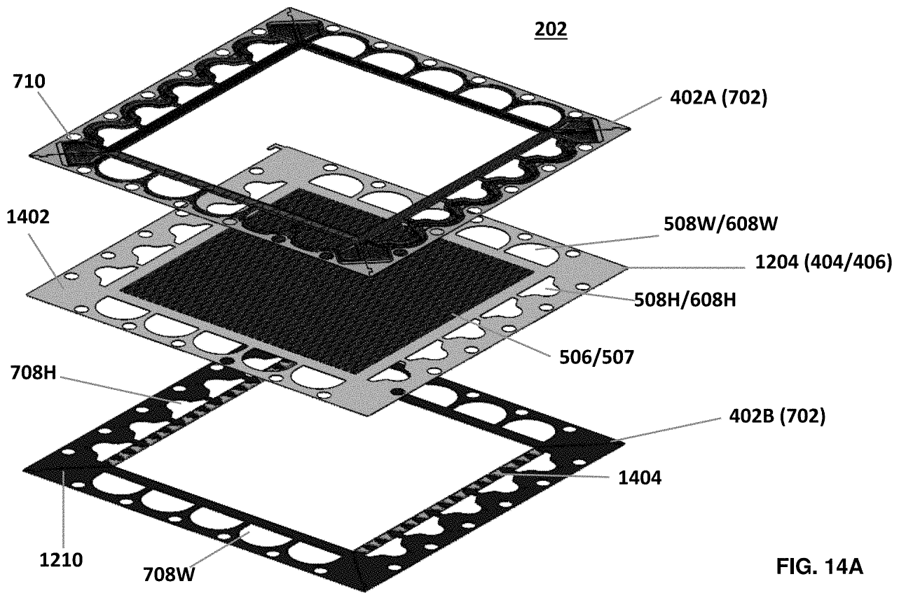

FIGS. 13A to 13C illustrate an adhesive bonding process whereby a plastic component 1202 and a metal component 1204 may be bonded to one another, according to various embodiments. In FIG. 13A the plastic component 1202 and the metal component 1204 may be aligned relative to one another prior to bonding by an adhesive bonding process. For example, plastic component may be an edge of a capping plate 402a or 402b (e.g., see FIGS. 4A and 4B), or may be an edge of a first section 702a or a second section 702b of a capping plate 702 (e.g., see FIG. 11). Similarly, the metal component 1204 may be an edge of an anode plate 404 or a cathode plate 406 (e.g., see FIGS. 4A, 4B, and 11). An adhesive 1210 may be applied between the plastic component 1202 and the metal component 1204, as shown in FIG. 13B. The adhesive 1210 may act to form a bond 1212 between the plastic component 1202 and the metal component 1204 thereby bonding the plastic component 1202 and the metal component 1204 to one another, as shown in FIG. 13C. During the bonding process, the plastic component 1202 and the metal component 1204 may be held together under pressure. For example, the plastic component 1202 and the metal component 1204 may be held together with clamps or may be held together with various other fastening devices.

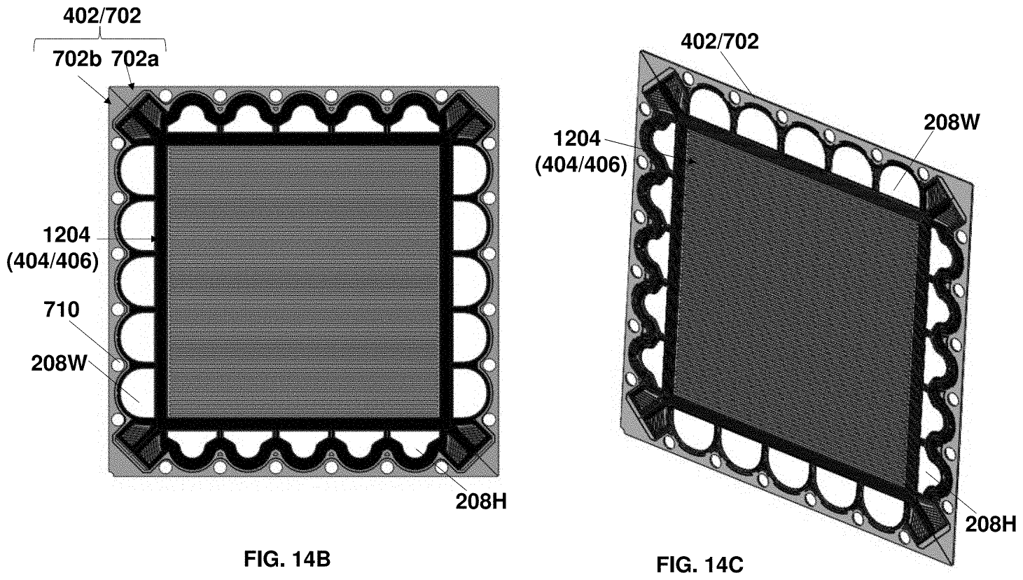

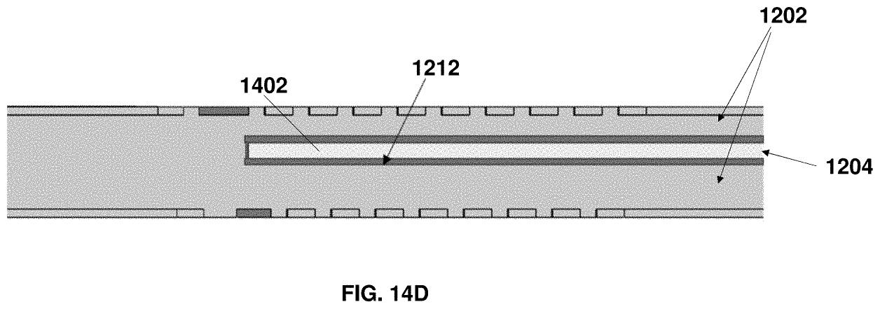

FIGS. 14A-14C illustrate various views of an electrochemical cell 202 according to an embodiment. In this embodiment, the metal component 1204 may comprise a unitary anode and cathode plate 1204 (i.e., 404/406). The plate 1204 may comprise a stainless steel plate or another suitable conductive material plate. The unitary anode and cathode plate 1204 includes an anode flow field (i.e., water flow field) containing anode channels 506 separated by anode ribs 507 on one major side of the plate 1204 and a cathode flow field (i.e., hydrogen flow field) containing cathode channels 606 separated by cathode ribs 607 on the opposite major side of the plate 1204. The plate 1204 may also include a metal lip 1402 that extends around the periphery of the of the water and hydrogen flow fields. The water/oxygen plenum areas 508W/608W extend through two opposing sides of the lip 1402. The hydrogen plenum areas 508H/608H extend through two additional opposing sides of the lip 1402 to form a cross flow plate 1402. Alternatively, the metal component 1204 may comprise separate anode plate 404 and cathode plate 406 that are placed back to back, as described in the previous embodiments.

The anode side capping plate 402A (e.g., 702) is located over the water flow field on the plate 1204. The cathode side capping plate 402B is located over the hydrogen flow field on the plate 1204. The cathode side capping plate 402B includes flow channels 1404 which fluidly connect the hydrogen plenum areas 708H to the hydrogen flow field on the bottom of the plate 1204. There are no channels in the cathode side capping plate 402B from the water and oxygen plenum areas 708W to the hydrogen flow field on the bottom of the plate 1204.

The anode side capping plate 402A includes water and oxygen flow channels (not shown) which connect the water and oxygen plenum areas 708W to the water flow field on top of the plate 1204. There are no channels in the anode side capping plate 402A from the hydrogen plenum areas 708H to the water flow field on the top of the plate 1204.

As shown in FIG. 14A, the adhesive 1210 is coated on the capping plates 402A, 402B forms a bond 1212 with the side of the lip 1402 of the plate 1204 which faces the respective capping plate. Thus, each capping plate 402A, 402B is bonded to the opposite side of the lip 1402 of the plate 1204. Thus, the plate 1204 is bonded to each of the capping plates 402A, 402B in this embodiment.

As shown in FIGS. 14A-14C, the hydrogen plenum areas 508H/608H and 708H together form hydrogen riser channels 208H. The water and oxygen plenum areas 508W/608W and 708W together form water and oxygen riser channels 208W. In one embodiment, the hydrogen riser channels 208H may have a different cross sectional shape and/or area from the water and oxygen riser channels 208W. For example, the hydrogen riser channels 208H may have a smaller cross sectional area than the water and oxygen riser channels 208W. The hydrogen riser channels 208H may have two concave sidewalls, while the water and oxygen riser channels 208W may have a roughly semi-circular shape having only flat and convex sidewalls and no concave sidewalls.

FIG. 14D is a vertical cross-sectional view of a plastic component 1202 and a metal component 1204 that have been bonded by an adhesive, according to various embodiments. In this example, the plastic component 1202 (e.g., the first section 702a or a second section 702b of a capping plate 702 shown in FIG. 11) may include a slot into which the metal component 1204 has been placed. An adhesive 1210 may be placed in the slot that may come in contact with the plastic component 1202 and the metal component 1204. As such, the adhesive 1210 may form a bond 1212 between the plastic component 1202 and the metal component 1204.

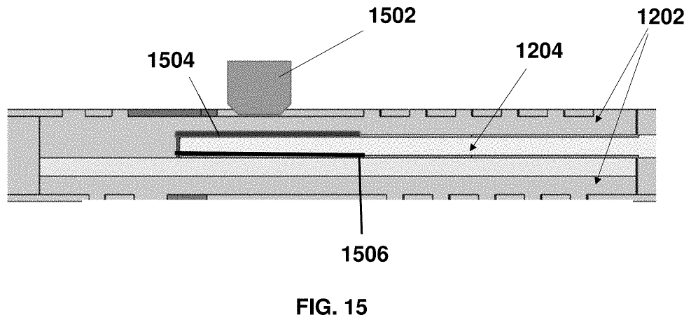

FIG. 15 is a vertical cross-sectional view of a plastic component 1202 and a metal component 1204 that may be bonded by an ultrasonic welding process, according to various embodiments. In this example, the plastic component 1204 (e.g., the first section 702a or a second section 702b of a capping plate shown in FIG. 11) may include a slot into which the metal component 1204 has been placed. A transducer 1502 may be configured to generate ultrasonic vibrations within the plastic component 1202 and the metal component 1204. The ultrasonic vibrations may cause vibrational energy to be absorbed by the plastic component 1202 and the metal component 1204 thereby generating heat within the plastic component 1202 and the metal component 1204. The heat may cause portions of the plastic component 1202 to melt thereby generating a first welded portion 1504 and a second welded portion 1506. The plastic component 1202 and thereby become bonded to the metal component 1204 at the first welded portion 1504 and the second welded portion 1506.

In other embodiments, a bonding process involving laser welding may be use to bond the plastic component 1202 to the metal component 1204. In further embodiments, individual sections of the plastic component 1202 (e.g., the first section 702a or a second section 702b of a capping plate shown in FIG. 11) may be bonded to the metal component 1204 by using a microwave/RF energy source to generate heat that thereby welds the plastic component 1202 to the metal component.

In other embodiments, a compaction bonding process may be applied to bond the plastic component 1202 to the metal component 1204. Further embodiments may include an interfacial layer (not shown) that may be generated to match a coefficient of thermal expansion between the plastic component 1202 and the metal component 1204 to mitigate mechanical strain between the plastic component 1202 and the metal component 1204 due to temperature changes during operation of an electrochemical cell (e.g., see FIGS. 2A and 2B) that may include the plastic component 1202 and the metal component 1204. In other embodiments, a bonding layer (not shown) between the plastic component 1202 and the metal component 1204 may be formed by dispensing a nano/microscale material and/or by using a nano/microscale CVD process. The plastic component 1202 and the metal component 1204 may be separately formed using injection or compression molding or stamping. Further embodiments may include the use of bonding layers (not shown) which may cure from a liquid to a solid (e.g., using an epoxy material) to bond the plastic component 1202 to the metal component 1204. For example, the bonding layers may be cured using by application of ultraviolet or other light to the bonding layers.

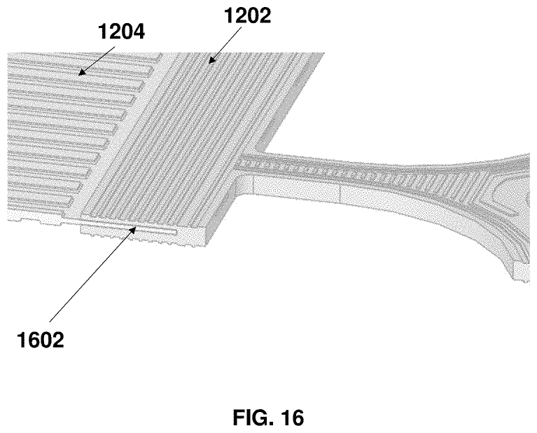

FIG. 16 is a three-dimensional perspective view of a plastic component 1202 that is formed directly on a metal component 1204, according to various embodiments. For example, a three-dimensional printing process may be performed to form the plastic component 1202 onto the metal component. In this example, the metal component 1204 may have a straight edge 1602 onto which the plastic component 1202 is formed. As such, the metal component 1204 may be an anode plate 404 or a cathode plate 406 having straight edges as shown, for example, in FIG. 11. Alternatively, the metal component 1204 may be an anode plate 404 having first molded-on hoop features 504 (e.g., see FIGS. 5A to 5C) or a cathode plate 406 having second molded-on hoop features 604 (e.g., see FIGS. 6A to 6C). As such, the plastic component 1202 may be directly formed onto the first molded-on hoop features 504 or the second molded-on hoop features 605 of the respective anode 404 or the cathode plate 406 (not shown).

In various other embodiments, the plastic component 1202 may include a glass or fiber rein reinforced plastic to improve the strength of the plastic component 1202. In further embodiments, one of the plastic component 1202 and the metal component 1204 may include a rivet type feature (not shown) and the other of the plastic 1202 and the metal component 1204 may include corresponding hole. The rivet type feature and the corresponding hole may be configured such that the rivet of one component may be pushed through the hole of the other component to thereby fuse the two components to one another. In other embodiments, the plastic component 1202 and the metal component 1204 may have interlocking mechanical features (not shown) that may allow the plastic component 1202 and the metal component 1204 to be mechanically joined. For example, at least one of the plastic component 1202 and the metal component 1204 may be configured to have reverse pitched “shark teeth” features (not shown) such that when the two components are joined, the two components may slip together—but cannot be pulled apart.

Further embodiments may include a marking layer (not shown) at an interface between the plastic component 1202 and the metal component 1204. The marking layer may be configured to interact with either hydrogen and/or oxygen and may thereby act as a fingerprint for a leak. The above-described hybrid plates 202, 202a, and 202b (e.g., see FIGS. 2A, 2B, 4A, 4B, 9A, 10A, 10B) may be configured to allow orthogonal flow paths. For example, the channels 506 of the anode plate 404 may be aligned in an orthogonal configuration relative to the channels 606 of the cathode plate 406 when forming a hybrid plate 202, as shown in FIGS. 4A and 4B. In other embodiments, magnetic elements (not shown) may be incorporated into plastic portions 1202 of the stack such that the magnetic fields may be used enhance the PEM performance. In further embodiments, a double seal between the plastic component 1202 and the metal component 1204 may be formed using any of the above-described bonding methods. As such, a space between the double seal (not shown) may be directed to a vent or a discharge pathway. In various embodiments, a reference electrode (e.g., a thin platinum wire) may be incorporated on the hydrogen side of a cell (not shown) to enable separation of anode vs. cathode.

Various alternative embodiments may include molded-in voltage probe wires. For example, a plastic component 1202 may include wires or traces that are molded into the plastic component 1202 such that the wires or traces are connected to the conductive flow field element (e.g., to the metal component 1204). The wires or traces may allow voltage measurements to be made. Similarly, one or more diodes or switches (e.g., transistors) may be mounted adjacent to, inside, or on the plastic component 1202 with wires or traces connecting two sides of cell. The diodes or switches (not shown) may be used to control or shunt bypass current around an electrochemical cell. In various embodiments, plenum areas 508, 608, and 708 may form input and output plenums for one cascaded stage or multiple cascaded stage of cells.

The hybrid plates 202 (e.g., see FIGS. 4A and 4B) may include current sensing elements (not shown) to allow for measurement of the current flowing through a cell or portions of a cell, in various embodiments. In further embodiments, the plastic component 1202 may be configured to hold a matrix of multiple metal components 1204, which may be connected directly in parallel or switched in parallel via lateral transistors, devices, switches or shunts. An electrochemical stack may be assembled with an anode/coolant plate as a first plate and a cathode/coolant plate a second plate. The first and second plates may be assembled into a stack which requires liquid coolant in alternating fashion. Alternatively, additional layers or passages may be provided in two conductive insert pieces (e.g., the core molding insert 801 of FIGS. 8A and 8B) such that a coolant passage is formed between layers which create the anode and cathode flow fields. In these embodiments, materials facing the coolant may be different from the materials selected to face the anode or cathode.

In various embodiments, the inner conductive anode and cathode layers may be formed of materials which are optimized for the electrochemical cell being created. For a PEM fuel cell or hydrogen pumping cell, for example, the inner layers may include a conductive carbon, thin foil graphite, coated stainless steel, etc. For a PEM electrolyzer cell, the anode layer may be coated stainless steel or titanium material and the cathode layer may include conductive carbon, thin foil graphite, coated stainless steel, or other appropriate metal layers. For an OH conducting electrolysis cell, the inner layers may include nickel or a metal which is appropriate for that cell chemistry.

The disclosed embodiments provide various advantages relative to conventional systems. For example, the above-described bonding processes are significantly more cost effective than diffusion bonding. Further, the hybrid cell 202 (e.g., see FIGS. 4A and 4B) may be mechanically stronger than a corresponding diffusion bonded cell. The plastic component 1202 (e.g., capping plates 402 of FIGS. 7A and 7B) may be bonded, glued or otherwise joined without creating a short circuit around the cell because the plastic is a dielectric material. Further, plastic components 1202 are more easily formed into forming sealing ridges whereas metal stamped structures make the formation of such sealing ridges more difficult. The center metal portion 1202 (e.g., the anode plate 404 and the cathode plate 406 of FIGS. 4A and 4B) may be very easily stamped, with complex plenum portions 508, 608, 708 formed from plastic via molding, as described above with reference to FIGS. 8A to 9B. Further, any coatings may only be formed on the center stamped metal portion 1204 without necessarily coating the plastic component 1202.

It will be appreciated that the methods and systems described above are set forth by way of example and not of limitation. Numerous variations, additions, omissions, and other modifications will be apparent to one of ordinary skill in the art. In addition, the order or presentation of method operations in the description and drawings above is not intended to require this order of performing the recited operations unless a particular order is expressly required or otherwise clear from the context. Thus, while particular embodiments have been shown and described, it will be apparent to those skilled in the art that various changes and modifications in form and details may be made therein without departing from the scope of the disclosure.

What is claimed is:

1. A bipolar plate, comprising:
at least one electrically conductive plate having an anode flow field on an anode major side and a cathode flow field on a cathode major side opposite to the anode major side;
an electrically insulating first capping plate containing a first plenum area, and located over the anode major side; and
an electrically insulating second capping plate containing a second plenum area, and located over the cathode major side,
wherein the at least one electrically conductive plate, the first capping plate and the second capping plate are bonded to each other.

2. The bipolar plate of claim 1, wherein:
the at least one electrically conductive plate comprises carbon, metal, or a metal alloy, and the first and second capping plates comprise electrically insulating plastic; and
each of the anode and the cathode flow fields comprise fluid flow channels separated by ribs.

3. The bipolar plate of claim 1, wherein the at least one electrically conductive plate comprises:
an electrically conductive anode plate having the anode flow field on a first major side; and
an electrically conductive cathode plate having the cathode flow field on a first major side, wherein a second major side of the cathode plate contacts a second major side of the anode plate.

4. The bipolar plate of claim 3, wherein the first and second capping plates are bonded to each other and to the anode and the cathode plates by molded plastic.

5. The bipolar plate of claim 1, wherein the at least one electrically conductive plate comprises a unitary anode and cathode plate containing the anode flow field on the anode major side and the cathode flow field on the cathode major side opposite to the anode major side.

6. The bipolar plate of claim 5, wherein the first and second capping plates are bonded to the unitary anode and cathode plate by solvent bonding, by an adhesive or by a direct bond generated by ultrasonic welding, laser welding, or microwave or RF welding.

7. The bipolar plate of claim 6, wherein:
the unitary anode and cathode plate contains a lip portion which surrounds the anode and the cathode flow fields;
the first and second capping plates are bonded to opposite sides of the lip portion of the unitary anode and cathode plate by the adhesive; and
fluid riser openings extend through third plenum areas in the lip portion and through the first and second plenum areas in the first and the second capping plates.

8. The bipolar plate of claim 1, wherein the first and second capping plates are formed on the at least one electrically conductive plate by a three-dimensional printing process.

9. An electrolyzer stack comprising the bipolar plate of claim 1, and an electrolyzer membrane electrode assembly.

10. The electrolyzer stack of claim 9, further comprising:
an anode side gas diffusion layer in contact with the bipolar plate and located on a first side of the electrolyzer membrane electrode assembly; and
a cathode side gas diffusion layer located on a second side the electrolyzer membrane electrode assembly.

11. The electrolyzer stack of claim 10, further comprising a second bipolar plate in contact with the cathode side gas diffusion layer.

12. The electrolyzer stack of claim 11, further comprising a plurality of bipolar plates, wherein the plurality of bipolar plates are stacked such that the anode flow field of each bipolar plate faces an anode side of a first cell and the cathode flow field of each bipolar plate faces a cathode side of a second cell, and wherein the plurality of bipolar plates in the stack are electrically connected in series.

13. A method of forming a bipolar plate, comprising:
providing at least one electrically conductive plate having an anode flow field on an anode major side and a cathode flow field on a cathode major side opposite to the anode major side;
providing an electrically insulating first capping plate containing a first plenum area such that the first capping plate is located over the anode major side;
providing an electrically insulating second capping plate containing a second plenum area, such that the second capping plate is located over the second major side; and
bonding the at least one electrically conductive plate, first capping plate and the second capping plate to each other.

14. The method of claim 13, wherein:
the anode plate and the cathode plate comprise carbon, metal, or a metal alloy, and the first and second capping plates comprise electrically insulating plastic; and
each of the first and the second flow fields comprise fluid flow channels separated by ribs.

15. The method of claim 13, wherein:
the step of providing at least one electrically conductive plate comprises placing an electrically conductive anode plate having a first flow field on a first side in contact with an electrically conductive cathode plate having a second flow field on a first side, such that a second side of the cathode plate contacts a second side of the anode plate; and
the step of bonding the at least one electrically conductive plate, first capping plate and the second capping plate to each other comprises bonding the first and second capping plates to each other and to the anode and the cathode plates by plastic injection molding.

16. The method of claim 15, wherein:
the step of providing the electrically insulating first capping plate comprises providing a pre-molded first capping plate;
the step of placing the electrically conductive anode plate in contact with the electrically conductive cathode plate comprises placing the anode plate on the first capping plate and placing the cathode plate on the anode plate;
the step of providing the electrically insulating second capping plate comprises placing the second capping plate on the cathode plate and on the first capping plate; and
the step of bonding the first capping plate and the second capping plate to each other comprises flowing liquid plastic material through channels over the first capping plate, the anode plate, the cathode plate and the second capping plate followed by solidifying the liquid plastic material to bond the first and second capping plates to each other and to the anode and the cathode plates.

17. The method claim 13, wherein the step of bonding the at least one electrically conductive plate, first capping plate and the second capping plate to each other comprises solvent bonding, adhesive bonding or direct bonding generated by ultrasonic welding, laser welding, or microwave or RF welding.

18. The method of claim 13, wherein the at least one electrically conductive plate comprises a unitary anode and cathode plate containing the anode flow field on the anode major side and the cathode flow field on the cathode major side opposite to the anode major side.

19. The method of claim 18, wherein:
the unitary anode and cathode plate contains a lip portion which surrounds the anode and the cathode flow fields;
the step of bonding the at least one electrically conductive plate, first capping plate and the second capping plate to each other comprises bonding the first and second capping plates to opposite sides of the lip portion of the unitary anode and cathode plate by an adhesive; and
fluid riser openings extend through third plenum areas in the lip portion and through the first and second plenum areas in the first and the second capping plates.

20. The method claim 13, further comprising placing the bipolar plate into an electrolyzer stack.
